(19) United States
(12) Patent Application Publication
(10) Pub. No.: US 2024/0059979 A1
(43) Pub. Date: Feb. 22, 2024

(54) PROCESS AND SYSTEM FOR HYDROTREATING RENEWABLE FEEDSTOCK

(71) Applicant: GREEN TECHNOLOGY RESEARCH CO., LTD., Bangkok (TH)

(72) Inventors: Supakorn SIRIMITRTRAKUL, Bangkok (TH); Nuttapong SODSAI, Nontaburi (TH)

(73) Assignee: GREEN TECHNOLOGY RESEARCH CO., LTD., Bangkok (TH)

(21) Appl. No.: 18/025,142

(22) PCT Filed: Sep. 8, 2021
(86) PCT No.: PCT/TH2021/000051

§ 371 Date: Mar. 7, 2023

(30) Foreign Application Priority Data
Sep. 9, 2020 (SG) 10202008815X

(51) Int. Cl. C10G 3/00; B01J 19/24; B01D 3/14

(52) U.S. Cl. CPC C10G 3/50; C10G 3/49; C10G 3/46; B01J 19/245; B01D 3/143; C10G 2300/1014; C10G 2300/1018; C10G 2300/1007; B01J 2219/0004

(57) ABSTRACT

The present invention provides a process for producing one or more of hydrocarbon products from a renewable feedstock comprising triglycerides, free fatty acids or combinations thereof. The process may comprise the steps of mixing the renewable feedstock with a diluent to form a diluted feedstock; supplying or providing hydrogen gas to the diluted feedstock so that the hydrogen gas may dissolve in the diluted feedstock to form a diluted feedstock enriched with dissolved hydrogen; and feeding the diluted feedstock enriched with dissolved hydrogen to at least a reactor having at least a reaction zone comprising at least a catalyst bed under predefined conditions, thereby producing a reaction effluent which can be further processed (e.g. by using one or more distillation units and one or more adsorption units) to form one or more of hydrocarbon products.

### TECHNICAL FIELD OF THE INVENTION

The present invention relates to a process and system for hydrotreating renewable feedstocks, particularly renewable feedstocks comprising triglycerides, free fatty acids or combinations thereof.

### BACKGROUND OF THE INVENTION

The following discussion of the background to the invention is intended to facilitate understanding of the present invention. However, it should be appreciated that the discussion is not an acknowledgment or admission that any of the material referred to was published, known or a part of the common general knowledge in any jurisdiction as at the priority date of the application.

Hydroprocessing typically refers to two separate processes, i.e. hydrotreating and hydrocracking. Hydrotreating is a process which uses hydrogen gas or a hydrogen-containing gas and a suitable catalyst or catalysts for breaking down complex oil molecules into smaller hydrocarbon molecules. Generally, the hydrotreating process is a three-phase process conducted in a trickle-bed reactor which is configured so that a selected renewable feedstock (such as animal oils, animal fats or plant oils) is in contact with a suitable catalyst or catalyst filled in the reactor under elevated temperature and pressure and in the presence of hydrogen gas (which flows continuously in the reactor).

In the reactor, when the hydrogen gas is in contact with the renewable feedstock, the hydrogen gas will dissolve in the renewable feedstock under certain conditions (e.g. at a temperature ranging from about 200° C. to about 400° C. and a pressure ranging from about 20 bar to about 50 bar), before any reaction can take place. Nevertheless, the low solubility of the hydrogen gas in the renewable feedstock imposes a limitation to the hydrotreating process, which contributes to a scenario where there is an insufficient amount of hydrogen for performing the reaction with the renewable feedstock.

To mitigate the foregoing limitation, the conventional hydrotreating process requires a large excess amount of hydrogen gas to be fed, which also leads to a large amount of unused hydrogen gas leaving the reactor together with the product stream. While the unused hydrogen gas can be recovered and reused by reinjecting into the reactor, it needs to be compressed by using a compressor to increase its pressure to a value that is at least equivalent to that of the reactor, thereby increasing the operating costs of the hydrotreating process.

In light of the above, there exists a need to develop a hydrotreating process that ameliorates at least one of the disadvantages mentioned above. There also exists a need to develop a process for hydrotreating a renewable feedstock to produce the desired hydrocarbon products including bio-naphtha, an industrial solvent, and phase change materials having high purity of n-paraffin.

### SUMMARY OF THE INVENTION

One of the aspects of the invention is to produce a hydrotreated oil that can be further processed to produce hydrocarbon products suitable for use in engines, car parts, buildings as well as other applications.

Another aspect of the invention is to produce a hydrotreated oil from a hydrotreating process without using a petrochemical source as a starting material or raw material.

Still another aspect of the invention is to produce a hydrotreated oil with high purity or to produce a hydrotreated oil which can be further processed to produce hydrocarbon products with high purity.

Yet another aspect of the invention is to provide a process for hydrotreating a feedstock comprising triglycerides, free fatty acids or combinations thereof, without the presence of a large excess amount of hydrogen gas.

In accordance with an aspect of the invention there is provided a process for producing one or more of hydrocarbon products from a renewable feedstock comprising triglycerides, free fatty acids or combinations thereof, the process comprising the steps of diluting the renewable feedstock with a diluent to form a diluted feedstock; contacting the diluted feedstock with hydrogen gas and sulfiding agent so that the hydrogen gas dissolves in the diluted feedstock to form a diluted feedstock enriched with dissolved hydrogen; subjecting the diluted feedstock enriched with dissolved hydrogen to a reactor comprising a catalyst bed to form a reaction effluent enriched with dissolved hydrogen; further contacting the reaction effluent with hydrogen gas and sulfiding agent so that the hydrogen gas dissolves in the reaction effluent to form a reaction effluent enriched with dissolved hydrogen; further subjecting the reaction effluent enriched with dissolved hydrogen to at least an additional reactor comprising a catalyst bed thereby producing a further-reaction effluent which can be further processed to form one or more of hydrocarbon products; and wherein gas volume fraction of undissolved hydrogen in the reactor is no more than 0.1 to 0.25.

In some embodiments, the process further comprising the step of passing hydrogen gas through each reactor at a predefined amount.

In some embodiments, the process further comprising the step of separating gaseous by-products from the reaction effluent or further-reaction effluent using a hot high-pressure separator.

In some embodiments, the diluting step and the contacting step can be performed simultaneously.

In some embodiments, the process further comprising the step of recovering the diluent from the reaction effluent or further-reaction effluent and reinjecting the recovered diluent to the diluent source.

In some embodiments, the process further comprising the steps of feeding the reaction effluent or further-reaction effluent to separators, which are arranged sequentially, for separating by-products from the reaction effluent or further-reaction effluent and for recovering the diluent from the reaction effluent or further-reaction effluent, thereby obtaining a hydrotreated product; and feeding the hydrotreated product to one or more distillation columns and adsorption units for purifying the hydrotreated product to obtain one or more of purified hydrocarbon products.

In some embodiments, the renewable feedstock is an animal oil, a plant oil, or a combination thereof.

In some embodiments, the renewable feedstock is a combination of one or more animal oils and one or more plant oils.

In some embodiments, the renewable feedstock is tallow oil, train oil, fish oil, bleached palm oil (BPO), refined bleached deodorized palm oil (RBDPO), palm olein, palm stearin, palm fatty acid distillate, canola oil, corn oil, sunflower oil, soybean oil, jatropha oil, balanites oil, rapeseed oil, tall oil, hempseed oil, olive oil, linseed oil, mustard oil, peanut oil, castor oil, coconut oil, or a combination of any two or more oils.

In some embodiments, the renewable feedstock is fresh oil, used oil, waste oil or any combination thereof.

In some embodiments, the diluent comprises n-paraffin.

In some embodiments, the diluent comprises n-paraffin comprising 12 carbon atoms.

In some embodiments, the ratio of the diluent to the renewable feedstock is about 99 wt % diluent/1 wt % feedstock to about 50 wt % diluent/50 wt % feedstock.

In some embodiments, the ratio of hydrogen gas to the volume of catalyst bed in the reactor is in the range of 3 or 900 Nm³/m³.

In some embodiments, the ratio of hydrogen gas to the renewable feedstock is in the range of about 10 to about 700 Nm³/m³ (about 0.001 to about 0.054 g/g).

In some embodiments, the catalyst is selected from the group consisting of NiMo, CoMo, NiCoMo and NiW.

In some embodiments, the catalyst comprises at least one of two transition metals selected from the group consisting of Ni and Mo.

In some embodiments, the catalyst further comprises another transition metal or a group V element.

In some embodiments, the catalyst is loaded on a support.

In some embodiments, the support is an acidic porous solid support selected from the group comprising alumina (Al₂O₃), silica (SiO₂) and a mixture of alumina and silica (Al₂O₃—SiO₂).

In some embodiments, the support is fluoride alumina, ZSM-12, ZSM-21, ZSM-22, ZSM-23, ZSM-32, ZSM-35, ZSM-38, ZSM-48, ZSM-57, SAPO-11, SAPO-31, SAPO-41, MAPO-11, MAPO-31, zeolite Y, zeolite L or β-zeolite.

In some embodiments, a system for producing one or more of hydrocarbon products from a renewable feedstock comprising triglycerides, free fatty acids or combinations thereof, the system comprising a reactor comprising a catalyst bed; wherein the reactor is for reacting a diluted feedstock enriched with dissolved hydrogen to produce a reaction effluent which can be further processed to form one or more of hydrocarbon products; wherein the diluted feedstock enriched with dissolved hydrogen is prepared by diluting a renewable feedstock comprising triglycerides, free fatty acids or combinations thereof using a diluent to form a diluted feedstock, followed by adding the sulfiding agent and passing hydrogen gas through the diluted feedstock so that the hydrogen gas dissolves in the diluted feedstock to form a diluted feedstock enriched with dissolved hydrogen; further comprising at least an additional reactor comprising a catalyst bed to further contacting the reaction effluent with hydrogen gas and sulfiding agent to form a reaction effluent enriched with dissolved hydrogen, the additional reactor is for reacting the effluent enriched with dissolved hydrogen to produce a further-reaction effluent which can be further processed to form one or more of hydrocarbon products; and wherein the gas volume fraction of undissolved hydrogen in the reactor is no more than 0.1 to 0.25.

In some embodiments, the reactor or the additional reactor is further used so that the sulfiding agent is added and the hydrogen gas is passing through the reactor at a predefined amount.

In some embodiments, the hot high-pressure separator located after each reactor or additional reactor for separating gaseous by-products from the reaction effluent or further-reaction effluent.

In some embodiment, the system further comprising one or more separators, which are arranged sequentially, for separating by-products from the reaction effluent or further-reaction effluent and for recovering the diluent from the reaction effluent or further-reaction effluent, thereby obtaining a hydrotreated product; and one or more distillation columns and adsorption units for purifying the hydrotreated product to obtain one or more of purified hydrocarbon products.

In some embodiments, the renewable feedstock used in the system is an animal oil, a plant oil, or a combination thereof.

In some embodiments, the renewable feedstock used in the system is a combination of one or more animal oils and one or more plant oils.

In some embodiments, the renewable feedstock used in the system is tallow oil, train oil, fish oil, bleached palm oil (BPO), refined bleached deodorized palm oil (RBDPO), palm olein, palm stearin, palm fatty acid distillate, canola oil, corn oil, sunflower oil, soybean oil, jatropha oil, balanites oil, rapeseed oil, tall oil, hempseed oil, olive oil, linseed oil, mustard oil, peanut oil, castor oil, coconut oil, or a combination of any two or more oils.

In some embodiments, the renewable feedstock used in the system is fresh oil, used oil, waste oil or any combination thereof.

In some embodiments, the diluent used in the system comprises n-paraffin.

In some embodiments, the diluent used in the system comprises n-paraffin comprising 12 carbon atoms.

In some embodiments, the ratio of the diluent to the renewable feedstock used in the system is about 99 wt % diluent/1 wt % feedstock to about 50 wt % diluent/50 wt % feedstock.

In some embodiments, ratio of hydrogen gas to the volume of catalyst bed in the reactor used in the system is in the range of 3 or 900 Nm³/m³.

In some embodiments, the ratio of hydrogen gas to the renewable feedstock used in the system is in the range of about 10 to about 700 Nm³/m³ (about 0.001 to about 0.054 g/g).

In some embodiments, the catalyst used in the system is selected from the group consisting of NiMo, CoMo, NiCoMo and NiW.

In some embodiments, the catalyst used in the system comprises at least one of two transition metals selected from the group consisting of Ni and Mo.

In some embodiments, the catalyst used in the system further comprises another transition metal or a group V element.

In some embodiments, the catalyst used in the system is loaded on a support.

In some embodiments, the support of catalyst used in the system is an acidic porous solid support selected from the group comprising alumina (Al₂O₃), silica (SiO₂) and a mixture of alumina and silica (Al₂O₃—SiO₂).

In some embodiments, the support of catalyst used in the system is fluoride alumina, ZSM-12, ZSM-21, ZSM-22, ZSM-23, ZSM-32, ZSM-35, ZSM-38, ZSM-48, ZSM-57, SAPO-11, SAPO-31, SAPO-41, MAPO-11, MAPO-31, zeolite Y, zeolite L or β-zeolite.

### BRIEF DESCRIPTION OF THE DRAWINGS

The invention will now be described, by way of example only, with reference to the accompanying drawings, in which:

FIG. 1 illustrates a schematic diagram showing a process for hydrotreating a feedstock comprising triglycerides, free fatty acids or combinations thereof, according to one embodiment of the invention; and

FIG. 2 illustrates a schematic diagram showing a process for hydrotreating a feedstock comprising triglycerides, free fatty acids or combinations thereof, to produce products including phase change materials and industrial solvents, according to one embodiment of the invention.

### DETAILED DESCRIPTION

Particular embodiments of the invention will now be described with reference to the accompanying drawings. The terminology used herein is for the purpose of describing particular embodiments only and is not intended to limit the scope of the invention. Additionally, unless defined otherwise, all technical and scientific terms used herein have the same meanings as commonly understood by one of ordinary skill in the art to which the invention belongs. Where possible, the same reference numerals are used throughout the figures for clarity and consistency.

As used herein, the term “phase change material (PCM)” refers to a straight chain hydrocarbon compound comprising essentially n-paraffin having 16 carbon atoms, 17 carbon atoms, and 18 carbon atoms.

As used herein, the term “substantially free”, “significantly free” or the like term when used in the context of a by-product (e.g., sulphur, olefins, aromatics, alcohols, or combinations thereof) in a compound (e.g., a hydrotreated product stream or a phase change material) refers to an amount of less than 100 parts per million by weight (ppmw), less than 50 ppmw, less than 20 ppmw, less than 10 ppmw, less than 5 ppmw or less than 1 ppmw in that compound.

Throughout the specification, unless the context requires otherwise, the word “comprise” or variations such as “comprises” or “comprising”, will be understood to imply the inclusion of a stated integer or group of integers but not the exclusion of any other integer or group of integers.

Throughout the specification, unless the context requires otherwise, the word “include” or variations such as “includes” or “including”, will be understood to imply the inclusion of a stated integer or group of integers but not the exclusion of any other integer or group of integers.

As used herein, the term “about” typically means+/−5% of the stated value, more typically +/−4% of the stated value, more typically +/−3% of the stated value, more typically +/−2% of the stated value, even more typically +/−1% of the stated value, and even more typically +/−0.5% of the stated value.

Throughout this disclosure, certain embodiments may be disclosed in a range format. It is appreciable that the description in range format is merely for convenience and brevity and should not be construed as a limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. Ranges are not limited to integers, and can include decimal measurements. This applies regardless of the breadth of the range.

Other aspects of the invention will become apparent to those of ordinary skill in the art upon review of the following description of specific embodiments of the invention in conjunction with the accompanying figures.

The present invention provides a two-phase hydrotreating process, which is different from the conventional three-phase hydrotreating process. Particularly, the two-phase hydrotreating process involves at least a liquid-phase renewable feedstock and a solid catalyst (or catalysts in some embodiments), with the liquid-phase renewable feedstock being the continuous phase in the reactor. More particularly, the two-phase hydrotreating process comprises at least: mixing the renewable feedstock with a diluent to form a diluted feedstock; adding sulfiding agent to the diluted feedstock; supplying or providing hydrogen gas to the diluted feedstock so that the hydrogen gas may dissolve in the diluted feedstock to form a diluted feedstock enriched with dissolved hydrogen; and feeding the diluted feedstock enriched with dissolved hydrogen to at least a reactor having at least a reaction zone comprising at least a catalyst bed under predefined conditions (such as under conditions which favour hydrogenation), thereby producing a reaction effluent which is hydrocarbon compounds comprising essentially n-paraffin. This reaction effluent can also be further processed (e.g. by using one or more distillation units and one or more adsorption units) to form an industrial solvent, a phase change material (PCM) or both. If more than one reactor is used in the two-phase hydrotreating process, it should be appreciated that the reaction effluent stream from the preceding reactor (e.g., the second reactor) may be contacted with hydrogen gas and sulfiding agent before feeding it to the subsequent reactor (e.g. the third reactor), so that hydrogen gas may dissolve in the reaction effluent stream for replenishing the reacted hydrogen in the hydrotreating process and the efficiency of the catalyst may be maintained.

In some embodiments, the renewable feedstock to be hydrotreated in the present invention may be any plant- or animal-derived oils, fats, free fatty acids and the like. In particular, the renewable feedstock may be any oils such as those containing triglycerides or free fatty acids, where the major component comprises aliphatic hydrocarbon chains having C₁₂ to C₂₀ moieties.

In some preferred embodiments, the renewable feedstock may be an oil derived from plants and/or animals and it may comprise one or more triglycerides. The renewable feedstock may also comprise a mixture of triglycerides. The renewable feedstock comprising one or more triglycerides may be derived from a plant selected from the group consisting of pine, rape seed, sunflower, jathropa, seashore mallow and combinations of any two or more thereof. The renewable feedstock comprising one or more triglycerides may also be a vegetable oil selected from the group consisting of canola oil, palm oil, coconut oil, palm kernel oil, sunflower oil, soybean oil, crude tall oil and combinations of any two or more thereof. The renewable feedstock comprising one or more triglycerides may further comprise poultry fat, yellow grease, tallow, used vegetable oils or oils from pyrolysis of biomass. The renewable feedstock may further be marine oils such as algal oils.

In some other preferred embodiments, the renewable feedstock may comprise triglycerides, free fatty acids or combinations thereof. The renewable feedstock may be plant-derived oils, animal-derived oils or combinations thereof, where the oils may comprise major component comprising aliphatic hydrocarbon chains having C₁₂ to C₁₈ carbon atoms. The renewable feedstock comprising triglycerides, free fatty acids or combinations thereof may include but not limited to animal oils such as tallow oil, train oil and fish oil; plant oils such as bleach palm oil (BPO), refined bleached deodorized palm oil (RBDPO), palm olein, palm stearin, palm fatty acid distillate, canola oil, corn oil, sunflower oil, soybean oil, oils from desertic plants (such as jatropha oil and balanites oil), rapeseed oil, tall oil, hempseed oil, olive oil, linseed oil, mustard oil, peanut oil, castor oil, coconut oil; or a combination of any two or more thereof. The plant oils herein may also be vegetable oils which may be crude, refined or edible vegetable oils. In certain embodiments, the renewable feedstock may be fresh oil, used oil, waste oil or any combination thereof. Further, selection of the renewable feedstock may depend on availability and cost, thereby making the two-stage hydrotreating process flexible.

As mentioned in the preceding description, the present invention requires that a diluent be supplied or provided for mixing with the renewable feedstock to form a diluted feedstock. Formation of a diluted feedstock facilitates in enabling the hydrogen gas to dissolve in the diluted feedstock before feeding to a reactor. The formation of the diluted feedstock also eliminates the need of supplying a large excess amount of hydrogen gas to the reactor, as the hydrogen gas required for the hydrotreating process is present in the diluted feedstock in form of dissolved hydrogen.

In some embodiments, although the hydrogen gas may dissolve in the diluted feedstock before feeding to the reactor, the solubility of the hydrogen in the diluted feedstock may remain to be low, as shown in Table 1. Accordingly, it may affect the performance of the hydrotreating process, as the amount of hydrogen available for the hydrotreating process may be limited and insufficient.

TABLE 1
Solubility of hydrogen gas in diluted feedstocks

| Feedstock/Diluent | Solubility of hydrogen (wt %) |
|---|---|
| Palm oil/hydrotreated palm oil (10:90 | Approximately 0.05 to 0.10 |
| by weight) (diluted feedstock with | |
| diluent with short carbon atom chain) | |
| Pyrolysis oil/hydrotreated pyrolysis | Approximately 0.20 to 0.30 |
| oil (10:90 by weight) | |

To overcome such situation, more than one reactor may be used in the present invention, where each reactor may comprise at least a reaction zone comprising at least a catalyst bed. In particular, upon obtaining a reaction effluent stream from the preceding reactor (e.g. the first reactor), it may be essential to contact such reaction effluent stream from the first reactor with hydrogen gas, before feeding it to the subsequent reactor (i.e. the second reactor), for replenishing the reacted hydrogen in the hydrotreating process. Accordingly, it ensures that sufficient hydrogen is present throughout the hydrotreating process.

It should be appreciated in some embodiments that the number of reactors may be determined based on the composition and amount of the renewable feedstock to be hydrotreated and also diluent. The number of rectors may also be determined by the temperature and pressure for conducting the hydrotreating process. After determining these factors, the amount of hydrogen gas required to contact with the diluted feedstock or the reaction effluent stream, the ratio of the hydrogen gas to the renewable feedstock, the number of times required to add the hydrogen gas to the reaction effluent stream, etc. may accordingly be determined.

In some embodiments, the two-phase hydrotreating process comprises three main reactions, which include hydrogenation of double bonds in the alkyl chain of fatty acids, decarboxylation and decarbonylation, and hydrogenation to produce alkanes. As a result, the two-phase hydrotreating process may produce products including but not limited to n-aliphatic hydrocarbons of the corresponding fatty acids and propane from triglyceride molecules, and by-products including but not limited to carbon monoxide and carbon dioxide (from the oxygen content in the triglycerides) and water which may be in form of vapour. Removal of water from the reactors is crucial, as presence of water may affect the catalyst lifetime and the hydrogen solubility in the renewable feedstock.

In addition to the reactors, the two-phase hydrotreating process may also involve at least one separator for removing by-products formed from the desired hydrotreated products. This is unlike the conventional hydrotreating process which requires that heat exchangers, separators and flash vessels be provided after each reactor for removing undesirable heat and by-products including water from the hydrotreated product stream from each reactor.

In some preferred embodiment, the separator used in the two-phase hydrotreating process maybe a hot high-pressure separator (HHPS). The HHPS may be located at the downstream of a reactor for separating undesirable gaseous by-products from the reaction effluent stream obtained from the reactor, before contacting the hydrotreated product stream with hydrogen gas. In some embodiments, the gaseous by-products to be separated from the reaction effluent stream may comprise water vapour, carbon dioxide, carbon monoxide, propane, hydrogen sulphide (H₂S), a small amount of hydrogen gas and a small amount of gaseous hydrotreated products.

In some other embodiments, the process of the present invention may further comprise selecting a suitable catalyst. The catalyst may be selected from the group consisting of NiMo, CoMo, NiCoMo and NiW. In certain embodiments, the catalyst may comprise at least one of the two transition metals selected from the group consisting of Ni and Mo. In certain embodiments, the catalyst may further comprise another transition metal or a group V element.

Prior to use, the catalyst may also be activated through a sulfiding process which may be accomplished by loading the catalyst into the reaction zone and reacting the metal oxides with hydrogen sulphide (H₂S) in the presence of hydrogen at a temperature of about 150° C. to about 400° C. and a pressure of about 1 bar to about 50 bar. The sulfiding agent may be selected from the group consisting of carbon disulphide, dicarbon disulphide and paraffin compound (CS-40) having at least one functional group of thiol, sulphide or disulphide. In some embodiments, the amount of sulphur in the sulfiding agent used in the activation of the catalyst may be about 0.10 wt % to 5 wt % or about two times of the required amount for transforming metal oxide to metal sulphide. In another aspect, the catalyst loading may be about 0.5 wt % to about 20 wt %. The amount of catalyst required may be calculated based on the amount of the renewable feedstock and hydrogen gas.

In some embodiments, the catalyst may be loaded on a support. In some preferred embodiment, the support to be loaded with the catalyst may be an acidic porous solid support such as alumina (Al₂O₃), silica (SiO₂) or a mixture of alumina and silica (Al₂O₃—SiO₂) In some other preferred embodiments, the support to be loaded with the catalyst may be fluoride alumina, ZSM-12, ZSM-21, ZSM-22, ZSM-23, ZSM-32, ZSM-35, ZSM-38, ZSM-48, ZSM-57, SAPO-11, SAPO-31, SAPO-41, MAPO-11, MAPO-31, zeolite Y, zeolite L or β-zeolite. By passing the diluted feedstocks enriched with dissolved hydrogen through the catalyst on the support, hydrogenation of the olefinic or unsaturated portions of the n-paraffinic chains of the renewable feedstock may take place. Additionally, as the support may act as a high surface area support for the catalyst, greater efficiency of the catalyst may be achieved. Accordingly, the reactions such as hydrogenation, deoxygenation and isomerization may occur with greater efficiency, because the catalyst is better dispersed.

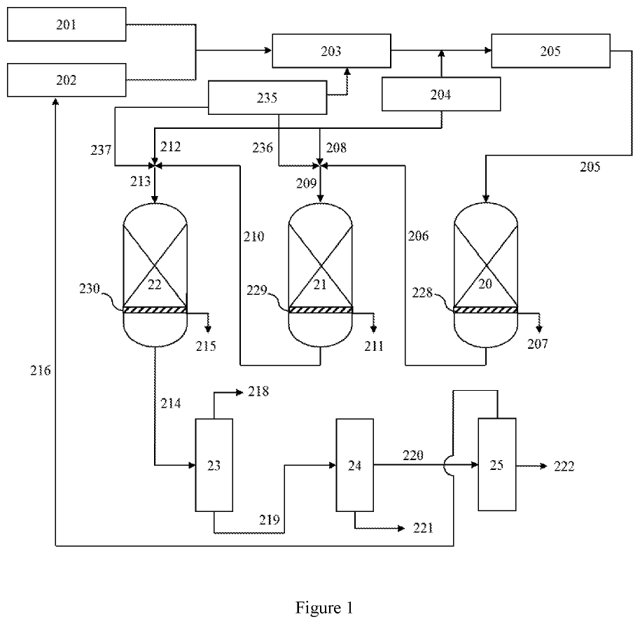

In some embodiments, the controlled rate of hydrogen gas added into at least one catalyst bed is determined to maximize the amount of hydrogen available for hydrogenation in all reaction zones and for all feedstocks and to minimize or eliminate the amount of hydrogen that exceeds the solubility limit. The ratio of hydrogen gas to the volume of catalyst bed may be in the range of 3, 20, 40, 50, 100, 150, 200, 250, 300, 350, 400, 500, 600, 700, 800 or 900 Nm³/m³. The feedstock may be in the range of about 10 to about 700 Nm³/m³ (about 0.001 to about 0.054 g/g), 10 to about 650 Nm³/m³ (about 0.001 to about 0.050 g/g), about 10 to about 600 Nm³/m³ (about 0.001 to about 0.047 g/g), about 10 to about 550 Nm³/m³ (about 0.001 to about 0.044 g/g), about 10 to about 500 Nm³/m³ (about 0.001 to about 0.039 g/g or), about 10 to about 450 Nm³/m³ (about 0.001 to about 0.035 g/g), about 10 to about 400 Nm³/m³ (about 0.001 to about 0.032 g/g), about 10 to about 380 Nm³/m³ (about 0.001 to about 0.030 g/g), about 10 to about 350 Nm³/m³ (about 0.001 to about 0.028 g/g) or about 10 to about 320 Nm³/m³ (about 0.001 to about 0.025 g/g). In some embodiments, it may be preferred to provide a process for hydrotreating a renewable feedstock 201 comprising triglycerides, free fatty acids or combinations thereof, as illustrated in FIG. 1. In particular, the renewable feedstock to be hydrotreated may be an animal oil or a plant oil. The renewable feedstock to be hydrotreated may also be a combination of one or more animal oils and one or more plant oils. For example, the renewable feedstock to be hydrotreated may be tallow oil, train oil, fish oil, bleached palm oil (BPO), refined bleached deodorized palm oil (RBDPO), palm olein, palm stearin, palm fatty acid distillate, canola oil, corn oil, sunflower oil, soybean oil, jatropha oil, balanites oil, rapeseed oil, tall oil, hempseed oil, olive oil, linseed oil, mustard oil, peanut oil, castor oil, coconut oil, or a combination of any two or more oils. In certain embodiments, the renewable feedstock to be hydrotreated may be fresh oil, used oil, waste oil or any combination thereof.

As illustrated in FIG. 1, it may be preferred before hydrotreating the renewable feedstock 201 that a diluent 202 be added to the renewable feedstock 201 to form a diluted feedstock 203. The diluent 202 to be added to the renewable feedstock 201 may be a fresh feed of n-paraffin, a portion of n-paraffin recovered from the process of this invention and reinjected into the diluent feeding stream or diluent source, or combinations thereof. In some preferred embodiments, the diluent 202 herein may comprise n-paraffin having C₁₀-C₂₀ carbon atoms. In particular, n-paraffin having C₁₂ carbon atoms. The composition of the diluent may be in range of 70-100 wt % of n-decane(C₁₀), n-undecane(C₁₁), n-dodecane(C₁₂), n-tridecane(C₁₃), n-tetradecane(C₁₄) or mixture thereof. The rest of the composition is heavier fraction of n-paraffin. In some other preferred embodiments, the diluent 202 may have an ability to maintain its liquid phase at a temperature of about 400° C. and a pressure of about 35 bar and also have a hydrogen solubility of not less than 0.5 wt %, 1.0 wt %, 2.0 wt % or 3 wt % at the hydrotreating reaction conditions which will be described below. Additionally, if the diluent 202 is a portion of n-paraffin recovered from the process of this invention and reinjected into the diluent feeding stream or diluent source, it may be essential to ensure that the relative volatility between the diluent 202 and the light key components in the n-paraffin effluent is more than or equivalent to 1.1.

Further, it should be appreciated that in certain embodiments, the ratio of the diluent 202 to the renewable feedstock 201 (that is added to the renewable feedstock 201) may be about 99 wt % diluent/1 wt % feedstock to about 95 wt % diluent/5 wt % feedstock, about 95 wt % diluent/5 wt % feedstock to about 90 wt % diluent/10 wt % feedstock, about 80 wt % diluent/20 wt % feedstock to about 70 wt % diluent/30 wt % feedstock or about 60 wt % diluent/40 wt % feedstock to about 50 wt % diluent/50 wt % feedstock. It should also be appreciated that in some embodiments, the feedstock 201 and the diluent 202 may be mixed with each other at ambient temperature and atmospheric pressure, thereby allowing the diluted feedstock 203 to be prepared in advance and kept in stock.

Subsequently, the diluted feedstock 203 may be contacted with the sulfiding agent 235 and then the hydrogen gas 204 so that a desired amount of hydrogen gas may be dissolved in the diluted feedstock 203 to prepare a diluted feedstock enriched with dissolved hydrogen 205 and the efficiency of the catalyst in the catalyst bed may be maintained. The amount of hydrogen gas may be present in an amount capable of dissolving in the feedstock or may be present in an excessive amount. The undissolved hydrogen gas may form gas phase in the reaction zone. The desired amount of hydrogen gas then must be sufficient for reaction or reactions in the reaction zone (depending on the volume of the feedstock required to be reacted in the reaction zone) and/or not form too much gas phase. In particular, gas phase occurred in this step would have Gas Volume Fraction (GVF) no more than about 0.1 to about 0.25. The desired amount of sulfiding agent is preferably to make sulphur 0-10,000 ppmw compared to the volume of the feedstock in the liquid stream. The operation or step for preparing the diluted feedstock enriched with dissolved hydrogen 205 may be carried out in any suitable apparatus known in the art. However, to enable dissolution of hydrogen gas in the diluted feedstock 203, it needs to be conducted under a condition having a temperature of about 200° C. to about 400° C., about 250° C. to about 320° C. or about 250° C. to 360° C. and a pressure of about 20 bar to about 100 bar, about 25 bar to about 100 bar or about 30 bar to about 100 bar. In some preferred embodiments, the ratio of the hydrogen gas 204 (to be fed to the diluted feedstock 203) to the diluted feedstock 203 may be about 0.00046 to about 0.00233 g/g.

In some embodiments, the step of adding sulfiding agent 235 can be made prior to reacting step in the reaction zones. For instance, the sulfiding agent 235 can be added to the renewable feedstock 201 during a mixing with the diluent or to the diluted feedstock prior to contacting with the hydrogen gas or to the diluted feedstock enriched with dissolved hydrogen 205 before introducing in to the reactor.

In some alternate embodiments, the diluted feedstock enriched with dissolved hydrogen 205 may be prepared in a single-step operation, instead of the two-step operation as described in the preceding description. In particular, the diluted feedstock enriched with dissolved hydrogen 205 may be prepared by feeding the renewable feedstock 201, diluent 202 and hydrogen gas 204 simultaneously. The ratio of the diluent 202 to the renewable feedstock 201 to may be about 99 wt % diluent/1 wt % feedstock to about 95 wt % diluent/5 wt % feedstock, about 95 wt % diluent/5 wt % feedstock to about 90 wt % diluent/10 wt % feedstock, about 80 wt % diluent/20 wt % feedstock to about 70 wt % diluent/30 wt % feedstock or about 60 wt % diluent/40 wt % feedstock to about 50 wt % diluent/50 wt % feedstock, whereas the ratio of the hydrogen gas 204 to the renewable feedstock 202 may be about 10 to about 700 Nm³/m³ (about 0.001 to about 0.054 g/g or about 0.1% wt to about 5.4% wt), 10 to about 650 Nm³/m³ (about 0.001 to about 0.050 g/g or about 0.1% wt to about 5% wt), about 10 to about 600 Nm³/m³ (about 0.001 to about 0.047 g/g or 0.1% wt to about 4.7% wt), about 10 to about 550 Nm³/m³ (about 0.001 to about 0.044 g/g or about 0.1% wt to about 4.4% wt), about 10 to about 500 Nm³/m³ (about 0.001 to about 0.039 g/g or 0.1% wt to about 3.9% wt), about 10 to about 450 Nm³/m³ (about 0.001 to about 0.035 g/g or about 0.1% wt to about 3.5% wt), about 10 to about 400 Nm³/m³ (about 0.001 to about 0.032 g/g or about 0.1% wt to about 3.2% wt), about 10 to about 380 Nm³/m³ (about 0.001 to about 0.030 g/g or about 0.1% wt to about 3.0% wt), about 10 to about 350 Nm³/m³ (about 0.001 to about 0.028 g/g or about 0.1% wt to about 2.8% wt) or about 10 to about 320 Nm³/m³ (about 0.001 to about 0.025 g/g or about 0.1% wt to about 2.5% wt).

In some embodiments, a selection of ratio of hydrogen to the renewable feedstock for continuous liquid phase hydrotreating mainly depends on type of renewable feedstock. For example, in case of RBDPO, the ratio of hydrogen to the renewable feedstock is about at least 450 Nm³/m³ (at least 0.035 g/g or about 3.5 wt. %) or at least 385 Nm³/m³ (at least 0.030 g/g or about 3.0 wt. %) or at least 320 Nm³/m³ (at least 0.025 g/g or about 2.5 wt. %). In case of refined soybean oil, the ratio of hydrogen to the renewable feedstock is about at least 550 Nm³/m³ (at least 0.044 g/g) or at least 510 Nm³/m³ (at least 0.040 g/g or about 4.0 wt. %) or at least 385 Nm³/m³ (at least 0.035 g/g or about 3.5 wt. %). Each type of renewable feedstock differently consumes amount of hydrogen to produce treated oil because its triglyceride and fatty acid chain length and degree of unsaturation. Specifically, the hydrotreating of triglycerides contained shorter fatty acid chain and/or possessed higher degree of unsaturated requires a higher amount of hydrogen gas.

However, if the single-step operation is performed to prepare the diluted feedstock enriched with dissolved hydrogen 205, it should be appreciated that the single-step operation needs to be conducted at a temperature of about 200° C. to about 400° C., about 250° C. to about 320° C. or about 250° C. to 360° C. and a pressure of about 20 bar to about 100 bar, about 25 bar to about 100 bar or about 30 bar to about 100 bar. Accordingly, it would be unfeasible to prepare the diluted feedstock enriched with dissolved hydrogen 205 in advance and keep in stock.

After obtaining the diluted feedstock enriched with dissolved hydrogen 205, it may then be fed to a first reactor 20 having at least a reaction zone comprising at least a catalyst bed (which comprises at least an activated hydrotreating catalyst). For ease of description, the following embodiments will be described with respect to a reactor having a catalyst reaction zone, but it should however be appreciated that the number of reaction zones in the reactor shall not be limited thereto or thereby.

In particular, the diluted feedstock enriched with dissolved hydrogen 205 may be fed to the first reactor 20 in which the diluted feedstock enriched with dissolved hydrogen 205 may pass through a first catalyst bed comprising an activated hydrotreating catalyst. When the diluted feedstock enriched with dissolved hydrogen 205 is in contact with the activated hydrotreating catalyst, the olefinic or unsaturated portions of the n-paraffinic chains in the diluted feedstock enriched with dissolved hydrogen 205 are hydrotreated. The reaction effluent from the first reactor 20 may subsequently be directed to a first hot high-pressure separator (HHPS) 228 for separating undesirable gaseous by-products. For example water vapour, carbon dioxide, carbon monoxide, propane, hydrogen sulphide (H₂S), a small amount of hydrogen gas and a small amount of gaseous hydrotreated products. Accordingly, the undesirable gaseous by-products exit the first HHPS 228 as a waste stream 207 which will be directed to a waste treatment unit (not shown), whereas the separated reaction effluent exits the first HHPS 228 as a first effluent stream 206 comprising hydrotreated oil, unreacted feedstock, unreacted diluent, a small amount of hydrogen, a small amount of undesirable by-product.

Subsequently, the first effluent stream 206 may be contacted with a desired amount of hydrogen gas 208 and desired amount of sulfiding agent 236, before feeding it to a second reactor 21. The step of contacting the first effluent stream 206 with the hydrogen gas 208 and sulfiding agent 236 is crucial, as it facilitates in ensuring that sufficient hydrogen gas will be available for the subsequent hydrotreating reaction and the efficiency of the catalyst may be maintained.

After feeding the first effluent stream enriched with dissolved hydrogen 209 to the second reactor 21, the first effluent stream enriched with dissolved hydrogen 209 may pass through a second catalyst bed comprising an activated hydrotreating catalyst. When the first effluent stream enriched with dissolved hydrogen 209 is in contact with the activated hydrotreating catalyst, the olefinic or unsaturated portions of the n-paraffinic chains in the first effluent stream enriched with dissolved hydrogen 209 are hydrotreated. The reaction effluent from the second reactor 21 may then be directed to a second HHPS 229 for separating undesirable gaseous by-products. For example water vapour, carbon dioxide, carbon monoxide, propane, hydrogen sulphide (H₂S), a small amount of hydrogen gas and a small amount of gaseous hydrotreated products. Accordingly, the undesirable gaseous by-products exit the second HHPS 229 as a waste stream 211 which will be directed to a waste treatment unit (not shown), whereas the separated reaction effluent exits the second HHPS 229 as a second effluent stream 210 comprising hydrotreated oil, unreacted feedstock, unreacted diluent, a small amount of hydrogen, a small amount of undesirable by-product.

Similarly, before feeding the second effluent stream 210 to a third reactor 22, it is essential to contact the second effluent stream 210 with a desired amount of hydrogen gas 212 and desired amount of sulfiding agent 237 to dissolve the hydrogen gas and sulfiding agent in the second effluent stream 210. This is to ensure that sufficient hydrogen gas will be available for the subsequent hydrotreating reaction and the efficiency of the catalyst may be maintained. After feeding the second effluent stream enriched with dissolved hydrogen 213 to the third reactor 22, the second effluent stream enriched with dissolved hydrogen 213 may pass through a third catalyst bed comprising an activated hydrotreating catalyst. When the second effluent stream enriched with dissolved hydrogen 213 is in contact with the activated hydrotreating catalyst, the olefinic or unsaturated portions of the n-paraffinic chains in the second effluent stream enriched with dissolved hydrogen 213 are hydrotreated. The reaction effluent from the third reactor 22 may subsequently be directed to a third HHPS 230 for separating undesirable gaseous by-products. For example water vapour, carbon dioxide, carbon monoxide, propane, hydrogen sulphide (H₂S), a small amount of hydrogen gas and a small amount of gaseous hydrotreated products. Accordingly, the undesirable gaseous by-products exit the third HHPS 229 as a waste stream 215 which will be directed to a waste treatment unit (not shown), whereas the separated reaction effluent exits the third HHPS 230 as a third effluent stream 214 comprising hydrotreated oil, unreacted feedstock, unreacted diluent, a small amount of hydrogen, a small amount of undesirable by-product.

In some embodiments, the amount of hydrogen gas to be added in the second reactor and/or the third reactor may be present in an amount capable of dissolving in the feedstock or may be present in an excessive amount. The undissolved hydrogen gas may form gas phase in the reaction zone together with the gaseous by-products, for instance, carbon monoxide, carbon dioxide, propane, hydrogen sulfide. The desired amount of hydrogen gas then must be sufficient for reaction or reactions in the reaction zone (depending on the volume of the feedstock required to be reacted in the reaction zone) and/or must not form too much gas phase. In particular, gas phase occurred in this step would have Gas Volume Fraction (GVF) no more than about 0.1 to about 0.25. The desired amount of sulfiding agent is preferably to make sulphur 0-10,000 ppmw compared to the volume of the feedstock in the liquid stream.

Subsequently, a portion or preferably the entire third effluent stream 214 may be subjected to one or more separations for separating the impurities or gaseous contaminants which may be present or dissolved in the third effluent stream 214. In some embodiments, the third effluent stream 214 may be fed first to a flash vessel 23 for separating the gaseous contaminants present in the third effluent stream 214. In particular, the gaseous contaminants comprising water vapour, carbon dioxide, carbon monoxide, propane, hydrogen sulphide (H₂S), a small amount of hydrogen gas and a small amount of gaseous hydrotreated products may exit as a first top stream 218, while the remaining liquid mixture may exit as a first bottom stream 219 comprising hydrotreated oil, diluent and water which will be fed to a second separator 24. In some embodiments, the second separator 24 may be a low-pressure separator 24 for separating the water components from the first bottom stream 219. While the undesirable water components (separated from the first bottom stream 219) may exit the second separator 24 as a second bottom stream 221, the remaining liquid mixture may exit as a second stream 220. It should be appreciated that upon exiting the second separator 24, the second stream 220 is substantially free of gaseous contaminants and water components.

The second stream 220 may further be fed to a third separator 25 which may preferably be a distillation column. Presence of the third separator enables recovery of the diluent 216 from the second stream 220, so that the recovered diluent 216 may be reused by reinjecting into the diluent feeding stream or diluent source (prior to contact with the hydrogen gas 204). Further, upon recovery of the diluent from the second stream 220, the remaining liquid mixture may leave the third separator 25 as a hydrotreated product stream 222. In the preferred embodiment, the hydrotreated product stream 222 herein may be a hydrotreated oil phase comprising primarily a mixture of straight chain n-alkane hydrocarbon compounds. In particular, the hydrotreated product stream 222 may be bio-naphtha hydrocarbon compounds. The composition of the bio-naphtha hydrocarbon compounds may comprise at least 90% wt of n-paraffin and 0-10% wt of iso-paraffin, wherein the paraffins mainly fall within the C₇-C₁₈ range.

The hydrotreated product stream 222 may be further processed to form phase change materials (PCM), industrial solvents or both. In the more preferred embodiment, the hydrotreated product stream 222 may be a hydrotreated oil phase comprising a low volume of isoparaffin and a high volume of n-paraffin. The isoparaffin present in the hydrotreated product stream 222 may be substantially free of sulphur, olefins and aromatic compounds, thereby making the isoparaffin non-toxic while preventing formation of undesirable harmful products.

It should be appreciated that the present invention facilitates in minimising the loss of hydrogen gas from the hydrotreating process, such as from the reactors 20, 21, 22 and separators 23, 24, 25. The present invention also does not require that large excess amount of hydrogen gas be fed to each of the reactors, unlike the conventional processes. It is because the diluent 202 comprising essentially n-paraffin having 12 carbon atoms is added and mixed with the renewable feedstock 201 to form a diluted feedstock 203, thereby allowing hydrogen gas to dissolve easily in the diluted feedstock 203. By eliminating the need for feeding excessive hydrogen gas to the reactors while being able to minimise the loss of hydrogen gas throughout the hydrotreating process, the present invention offers more economic benefits as compared to the conventional processes.

In some embodiments a liquid hourly space velocity may be in range of about 0.5 to 10.0 Hr⁻¹, about 0.5 to 20.0 Hr⁻¹, about 0.5 to 30.0 Hr⁻¹, about 0.5 to 40.0 Hr⁻¹, about 0.5 to 50.0 Hr⁻¹, about 0.5 to 60.0 Hr⁻¹, about 0.5 to 70.0 Hr⁻¹, about 0.5 to 80.0 Hr⁻¹, about 0.5 to 90.0 Hr⁻¹, about 0.5 to 100.0 Hr⁻¹.

It should also be appreciated that although the catalysed reaction that takes place in the reactors 20, 21, 22 is an exothermic reaction or a reaction which releases heat, additional steps for removing heat from the reactors 20, 21, 22 are not required, as the heat generated from the catalysed reaction is not high due to the desired ratio between the renewable feedstock and the diluent in which the diluent may absorb heat generated from the reaction.

In further embodiments, it may also be preferred to provide a process for hydrotreating a renewable feedstock comprising triglycerides, free fatty acids or combinations thereof to produce products including phase change materials and industrial solvents.

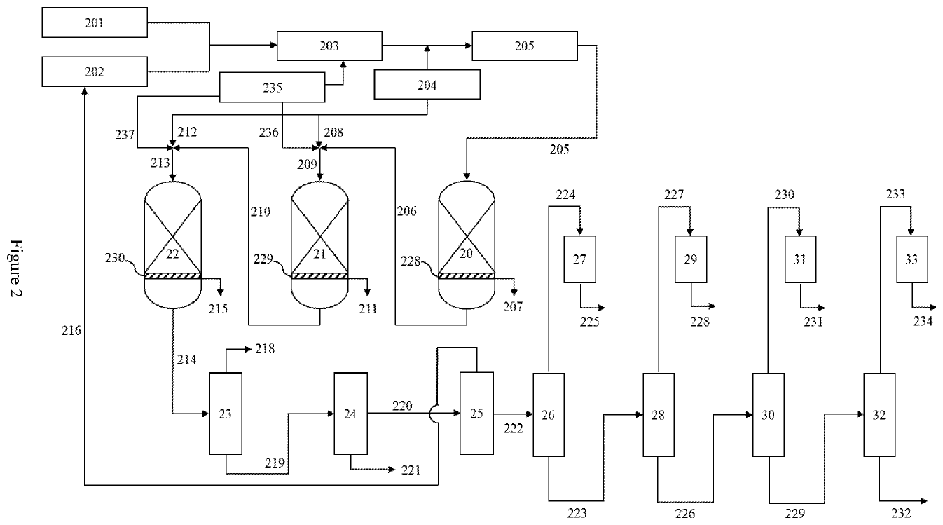

As shown in FIG. 2, the hydrotreated product stream 222 obtained from the hydrotreating process illustrated in FIG. 1 may be used and further processed through additional distillations and adsorptions to produce products including phase change materials (PCM) and industrial solvents. As the hydrotreated product stream 222 is substantially free of sulphur, olefins and aromatics, the PCM obtained from further processing the hydrotreated product stream 222 may also be substantially free of sulphur, aromatics and alcohols, as shown in Table 2.

In particular, the hydrotreated product stream 222 obtained from the hydrotreating process illustrated in FIG. 1 may be fed to a first distillation column 26, thereby producing a fourth top stream 224 comprising n-paraffin having less than 16 carbon atoms and a fourth bottom stream 223 which may be fed to a second distillation column 28. In some embodiments, the fourth top stream 224 may pass through a first adsorption unit 27, thereby producing a first fraction 225 comprising the desired industrial solvent.

In the second distillation column 28, the components in the fourth bottom stream 223 are separated to produce a fifth top stream 227 comprising n-hexadecane of at least about 99.0 wt % and a fifth bottom stream 226 which may be fed to a third distillation column 30. In some embodiments, the fifth top stream 227 may pass through a second adsorption unit 29, thereby producing a second fraction 228 comprising purified hexadecane or referred herein to as PCM #1.

In the third distillation column 30, the components in the fifth bottom stream 226 are separated to produce a sixth top stream 230 comprising n-heptadecane of at least about 99.0 wt % and a sixth bottom stream 229 which may be fed to a fourth distillation column 31. In some embodiments, the sixth top stream 230 may pass through a third adsorption unit 31, thereby producing a third fraction 231 comprising purified heptadecane or referred herein to as PCM #2.

In the fourth distillation column 32, the components in the sixth bottom stream 229 are separated to produce a seventh top stream 233 comprising n-octadecane of at least about 99.0 wt % and a seventh bottom stream 232 which may be used as a fuel oil (or bunker oil) suitable for applications such as but not limited to fuels for mobile engines. In some embodiments, the seventh top stream 233 may pass through a fourth adsorption unit 33, thereby producing a fourth fraction 234 comprising purified octadecane or referred herein to as PCM #3.

In some other embodiments, a single fractional distillation column may be used to obtain multiple products including industrial solvent, PCM #1, PCM #2 and PCM #3, instead of using multiple distillation columns 26, 28, 30, 32. It should also be appreciated that by providing adsorption units 27, 29, 31, 33 to process the top streams 224, 227, 230, 233, it facilitates in improving the quality of these streams by eliminating undesirable impurities or contaminants contained therein. For example, the adsorption units 27, 29, 31, 33 may function to remove undesirable components such as but not limited to volatile organic compounds, substances that may impart a bad odour or colour to the industrial solvent and/or PCM. Upon removal of these undesirable components, it may minimise or substantially eliminate undesirable characteristics such as bad odour or undesirable colour from the industrial solvent and/or PCM. Further, the adsorption units may function at atmospheric pressure, temperature of about 30° C. to about 70° C. and at a space velocity of about 0.5 h⁻¹ to 2.0 h⁻¹. Although the operating temperature of the respective adsorption units may be selected according to the feed streams, the operating temperature of the adsorption units needs not be maintained, thus leading to ease of operation.

In some embodiments, the adsorption unit herein may comprise at least one adsorption column, each adsorption column comprising at least one adsorbent selected from the group consisting of activated carbon, basic ion exchange resin, acidic exchange resin, molecular sieve, basic chemical adsorbent and acidic chemical adsorbent. In certain embodiments, the molecular sieve may have a pore size ranging from about 3 Å to about 15 Å. In certain other embodiments, basic chemical adsorbent may preferably be used.

### EXAMPLES

### Example 1: Process for Hydrotreating Palm Oil

The commercially available NiMo/Al₂O₃ catalyst was loaded into the reactor and then activated to a sulphided form at a temperature of about 150° C. to about 340° C. and a pressure of about 35 bar for a period of about 24 hours in the presence of carbon disulphide as the sulfiding agent. The amount of sulphides in the sulfiding agent fed to the reactor was two times of the amount of the catalyst required for the sulfiding reaction based on the chemical equilibrium.

The refined bleached deodorised palm oil (RBDPO) was used as a renewable feedstock and mixed with dodecane as a diluent to form a diluted feedstock at room temperature and atmospheric pressure using a suitable mixing apparatus known in the art. The ratio of the diluent to the renewable feedstock was about 90:10 by weight. The sulfiding agent was added into the diluted feedstock and the diluted feedstock was then heated to a temperature of about 340° C. and pressurised to a pressure of about 50 to about 75 bar. Subsequently, excessive hydrogen gas was passed through the diluted feedstock, where a desired quantity of the hydrogen gas was dissolved in the diluted feedstock, thereby forming a diluted feedstock enriched with dissolved hydrogen. The amount of the hydrogen gas to be fed at this stage was about 30% of the total hydrogen gas to be fed throughout the entire hydrotreating process.

Next, the diluted feedstock enriched with dissolved hydrogen was fed to the first reactor having at least a reaction zone comprising a catalyst bed at an operating temperature of about 340° C. and an operating pressure of about 50 to about 75 bar to hydrogenate the effluent of olefinic or unsaturated portions of the n-paraffinic chains. The amount of hydrogen gas to the volume of catalyst bed in the first reactor was about 600 Nm³/m³. The reaction mixture was then passed through the first HHPS for separating water vapour and gaseous components therefrom, thereby obtaining the first reaction effluent.

Before introducing the first reaction effluent to the second reactor, the first reaction effluent was contacted with a desired amount of hydrogen gas (which was heated to a temperature of about 340° C. and pressurised to a pressure of about 50 to about 75 bar) and a desired amount of sulfiding agent to form a first reaction effluent enriched with dissolved hydrogen. The amount of hydrogen gas to be fed at this stage was about 17.5% of the total hydrogen gas to be fed throughout the entire hydrotreating process.

The first reaction effluent enriched with dissolved hydrogen was then introduced into the second reactor having at least a reaction zone comprising a catalyst bed at an operating temperature of about 340° C. and an operating pressure of about 50 to about 75 bar, to further hydrogenate the olefinic or unsaturated portions of the n-paraffinic chains in the first reaction effluent. The amount of hydrogen gas to the volume of the catalyst bed in the second reactor was about 400 Nm³/m³. The reaction mixture was then passed through the second HHPS for separating water vapour and gaseous components therefrom, thereby obtaining the second reaction effluent.

Before introducing the second reaction effluent to the third reactor, the second reaction effluent was contacted with a desired amount of hydrogen gas (which was heated to a temperature of about 340° C. and pressurised to a pressure of about 50 to about 75 bar) and a desired amount of sulfiding agent to form a second reaction effluent enriched with dissolved hydrogen. The amount of hydrogen gas to be fed at this stage was about 17.5% of the total hydrogen gas fed throughout the entire hydrotreating process.

The second reaction effluent enriched with dissolved hydrogen was then introduced into the third reactor having at least a reaction zone comprising a catalyst bed at an operating temperature of about 340° C. and an operating pressure of about 50 to about 75 bar, to further hydrogenate the olefinic or unsaturated portions of the n-paraffinic chains in the second reaction effluent. The amount of hydrogen gas to the volume of the catalyst bed in the third reactor was about 400 Nm³/m³. The reaction mixture was then passed through the third HHPS for separating water vapour and gaseous components therefrom, thereby obtaining the third reaction effluent.

Before introducing the third reaction effluent to the fourth reactor, the third reaction effluent was contacted with a desired amount of hydrogen gas (which was heated to a temperature of about 340° C. and pressurised to a pressure of about 50 to about 75 bar) and a desired amount of sulfiding agent to form a third reaction effluent enriched with dissolved hydrogen. The amount of hydrogen gas to be fed at this stage was about 17.5% of the total hydrogen gas fed throughout the entire hydrotreating process.

The third reaction effluent enriched with dissolved hydrogen was then introduced into the fourth reactor having at least a reaction zone comprising a catalyst bed at an operating temperature of about 340° C. and an operating pressure of about 50 to about 75 bar, to further hydrogenate the olefinic or unsaturated portions of the n-paraffinic chains in the third reaction effluent. The amount of hydrogen gas to the volume of the catalyst bed in the third reactor was about 400 Nm³/m³. The reaction mixture was then passed through the fourth HHPS to separate water vapour and gaseous components thereform, thereby obtaining the fourth reaction effluent.

The fourth reaction effluent (which was in an oil phase) was passed through a flash vessel for separating the dissolved gaseous components therefrom, thereby obtaining a first separated effluent. The first separated effluent was subsequently introduced to a low-pressure separator for separating the water vapour therefrom, thereby obtaining a second separated effluent. The second separated effluent was further passed through a distillation column for separating the diluent therefrom, thereby obtaining the desired hydrotreated product or more particularly hydrotreated oil.

Table 2 shows the properties of the hydrotreated oil obtained from the process described in Example 1.

TABLE 2

| Product Properties | Hydrotreated Oil |
|---|---|
| Specific Gravity | 0.77-0.79 g/ml |
| Flash Point | 120-130° C. |
| Acid Value | 0.01 to 0.20 |
| Iso-Paraffin Content | 0.0 to 10 wt % |
| Distillation Range | |
| Initial Boiling Point | 120 to 130° C. |
| Final Boiling Point | 320 to 330° C. |
| Pentadecane Content | 0 to 10 wt % |
| Hexadecane Content | 20 to 40 wt % |
| Heptadecane Content | 0 to 20 wt % |
| Octadecane Content | 20 to 50 wt % |

### Example 2: Process for Hydrotreating Palm Oil

The commercially available CoMo/Al₂O₃ catalyst was loaded into the reactor and then activated to a sulphided form at a temperature of about 150° C. to about 340° C. and a pressure of about 35 bar for a period of about 24 hours in the presence of dimethyl disulfide as the sulfiding agent. The amount of sulfides in the sulfiding agent fed to the reactor was two times of the amount of the catalyst required for the sulfiding reaction based on the stoichiometric requirement.

The refined bleached deodorised palm oil (RBDPO) was used as a renewable feedstock and mixed with treated oil product as a diluent to form a diluted feedstock at room temperature and atmospheric pressure using a suitable mixing apparatus known in the art. The ratio of the diluent to the renewable feedstock was about 99:1 by weight. The sulfiding agent was added into the diluted feedstock and the diluted feedstock was then heated to a temperature of about 320° C. and pressurised to a pressure of about 30 to about 40 bar. Subsequently, hydrogen gas was passed through the diluted feedstock, where a desired quantity of the hydrogen gas was dissolved in the diluted feedstock, thereby forming a diluted feedstock enriched with dissolved hydrogen. The amount of the hydrogen gas to be fed at this stage was about 50% of the total hydrogen gas to be fed throughout the entire hydrotreating process (Total Hydrogen is 3.0% wt. of Fresh Feed).

Next, the diluted feedstock enriched with dissolved hydrogen was fed to the first reactor having at least a reaction zone comprising a catalyst bed at an operating temperature of about 340° C. and an operating pressure of about 30 to about 40 bar to form treated oil. Liquid hourly space velocity is kept at 25.0 Hr-1. The reaction mixture was then passed through the first HHPS for separating water vapour and gaseous components therefrom, thereby obtaining the first reaction effluent.

Before introducing the first reaction effluent to the second reactor, the first reaction effluent was contacted with a desired amount of hydrogen gas (which was heated to a temperature of about 320° C. and pressurised to a pressure of about 30 to about 40 bar) and a desired amount of sulfiding agent to form a first reaction effluent enriched with dissolved hydrogen. The amount of hydrogen gas to be fed at this stage was about 50% of the total hydrogen gas to be fed throughout the entire hydrotreating process.

The first reaction effluent enriched with dissolved hydrogen was then introduced into the second reactor having at least a reaction zone comprising a catalyst bed at an operating temperature of about 320° C. and an operating pressure of about 30 to about 40 bar, to form treated oil. Liquid hourly space velocity is kept at 25.0 Hr-1. The reaction mixture was then passed through the second HHPS for separating water vapour and gaseous components therefrom, thereby obtaining the second reaction effluent.

The second reaction effluent was introduced to a low-pressure separator for separating the water therefrom, thereby obtaining a first separated effluent of hydrotreated oil. The properties of treated oil obtained from the Example 2 are shown in Table 3.

It should be appreciated that the treated oil obtained from Example 2 can be achieved without the step of separating the dissolved gaseous component by the flash vessel because the gaseous component may be essentially separated in the step of hot high-pressure separator. Furthermore, the treated oil obtained from Example 2 can also be achieved without the step of distillation, however the treated oil may exhibit a lower flash point.

Table 3 shows the properties of the hydrotreated oil obtained from the process described in Example 2.

| Product Properties | Treated Oil |
|---|---|
| Specific Gravity | 0.77-0.79 g/ml |
| Flash Point | 60-80° C. |
| Acid Value | 0.01-0.20 |
| Iso-Paraffin Content | 0.0 to 10% wt. |
| Distillation Range | |
| Initial Boiling Point | 250 to 260° C. |
| Final Boiling Point | 320 to 330° C. |
| Pentadecane Content | 0-10 wt. % |
| Hexadecane Content | 20-40 wt. % |
| Heptadecane Content | 0-20 wt. % |
| Octadecane Content | 20-50 wt. % |

### Example 3: Effect of Reduced Hydrogen Circulation Rate

In a conventional hydrotreating process, the reactor is typically operated as a trickle bed, where the hydrogen gas is transferred through the liquid-covered catalyst surface carrying out a continuous gas phase throughout the reactor. As a result, the trickle bed reaction requires a very large volume of hydrogen flow rate (hydrogen circulation rate) more than that of required by the reaction (hydrogen consumption rate) for maintaining a continuous gas phase. If the continuous gas phase is failed to maintain, it may cause a deactivation of the catalyst.

Typically, the hydrogen consumption rate used in the hydrotreating RBDPO is about 2.5 wt % to about 3.5 wt %, while the hydrogen consumption rate used in the conventional hydrotreating is about 200% of those hydrogen consumption rates.

The hydrotreated oil was prepared according to the process described in the Example 2 using two reactors with the following reaction conditions;
feedstock in this experiment is RBDPO;
the reaction temperature was about 320° C.;
the reaction pressure was about 35 bar;
treated oil was used as the diluent;
the ratio of the diluent to renewable feedstock was about 99:1 by weight;
the liquid space velocity was about 25.0 hr-1;
CoMo/Al₂O₃ in the sulfided form was used as the activated catalyst loaded into each reactor;
the amount of hydrogen to the renewable feedstock was about 3.5 to 6.0% wt hydrogen gas with an amount of 50% of the total hydrogen gas to be fed in the entire hydrotreating process was added in each reactor;
the HHPS was used to separate gaseous components and water vapour from the reaction effluent obtained from each reactor.

Table 4 shows the properties of the hydrotreated oil obtained from the process described in Example 3.

| Product | Ratio of Hydrogen to Renewable Feedstock | | | |
|---|---|---|---|---|
| Properties | 6% wt. | 5% wt. | 4% wt. | 3.5% wt. |
| Specific | 0.77-0.79 | 0.77-0.79 | 0.77-0.79 | 0.77-0.79 |
| Gravity | g/ml | g/ml | g/ml | g/ml |
| Flash Point | 60-80° C. | 60-80° C. | 60-80° C. | 60-80° C. |
| Acid Value | 0.01-0.20 | 0.01-0.20 | 0.01-0.20 | 0.01-0.20 |
| Iso-Paraffin | 0.0 to | 0.0 to | 0.0 to | 0.0 to |
| Content | 1.5% wt. | 1.5% wt. | 1.5% wt. | 1.5% wt. |
| Distillation | | | | |
| Range | | | | |
| Initial Boiling | 250 to | 250 to | 250 to | 250 to |
| Point | 260° C. | 260° C. | 260° C. | 260° C. |
| Final Boiling | 320 to | 320 to | 320 to | 320 to |
| Point | 330° C. | 330° C. | 330° C. | 330° C. |
| Pentadecane | 0-10 wt. % | 0-10 wt. % | 0-10 wt. % | 0-10 wt. % |
| Content | | | | |
| Hexadecane | 20-40 wt. % | 20-40 wt. % | 20-40 wt. % | 20-40 wt. % |
| Content | | | | |
| Heptadecane | 0-20 wt. % | 0-20 wt. % | 0-20 wt. % | 0-20 wt. % |
| Content | | | | |
| Octadecane | 20-50 wt. % | 20-50 wt. % | 20-50 wt. % | 20-50 wt. % |
| Content | | | | |

From Table 4, it is apparent that the product properties does not altered even though the hydrogen circulation rate used in the Example 3 was 3.5 wt % or 4 wt % or 5 wt % or 6 wt %. That is, the present invention provides benefit of using hydrogen recirculation rate in range of more than 200% or more than 175% or more than 150% or more than 125% or more than 100% of hydrogen consumption rate. Using excess hydrogen gas in the hydrotreating process under the present invention is not required.

### Example 4: Process for Producing Phase Change Materials (PCM) from the Hydrotreated Oil Obtained in Example 1

This example was the process for producing PCM from the hydrotreated oil obtained from the process described in Example 1. In particular, the hydrotreated oil was introduced to multiple distillation units and multiple adsorption units. The properties of the PCM are shown in Table 3.

Table 5 shows the properties of PCM obtained from the process described in Example 4.

TABLE 5

| | PCM #01 | PCM #02 | PCM #03 |
|---|---|---|---|
| Product Properties | (Hexadecane) | (Heptadecane) | (Octadecane) |
| Purity | Min 99.0 wt % | Min 99.0 wt % | Min 99.0 wt % |
| Heat of Melting | >200 J/g | >200 J/g | >200 J/g |
| Melting Point | 17-19° C. | 21-23° C. | 27-29° C. |
| | (18.4° C.) | (21.8° C.) | (28.5° C.) |
| Sulfur Content | >1 ppm | >1 ppm | >1 ppm |
| Aromatic Content | >1 ppm | >1 ppm | >1 ppm |

### Example 5: Effects of the Types of Renewable Feedstocks on the PCM as Produced

This example was carried out to display how the selection of the renewable feedstock would affect the properties of the PCM as produced.

The hydrotreated oil was prepared according to the process described in Example 1, using five reactors and the following reaction conditions:
The reaction temperature was about 360° C.;
The reaction pressure was about 50 to about 75 bar;
N-undecane was used as the diluent;
The ratio of the diluent to the renewable feedstock was about 90:10 by weight;
The liquid space velocity was about 10.0 hr⁻¹;
CoMo/Al₂O₃ in sulfided form was used as the activated catalyst loaded into each reactor;
The amount of hydrogen to the renewable feedstock was about 3.5% wt;
Hydrogen gas with an amount of 20% of the total hydrogen gas to be fed in the entire hydrotreating process was added in each reactor;
The amount of hydrogen to the volume of catalyst bed in the first reactor was 600 Nm³/m³;
The amount of hydrogen to the volume of catalyst bed in the second reactor was 400 Nm³/m³;
The amount of hydrogen to the volume of catalyst bed in the third reactor was 200 Nm³/m³;
The amount of hydrogen to the volume of catalyst bed in the fourth reactor was 100 Nm³/m³;
The amount of hydrogen to the volume of catalyst bed in the fifth reactor was 50 Nm³/m³; and
The HHPS was used to separate gaseous components and water vapour from the reaction effluent obtained from each reactor.

Table 6 shows the properties of PCM obtained from the process described in Example 4.

TABLE 6

| | Feedstock | | | | |
|---|---|---|---|---|---|
| | | Palm Fatty | | | |
| Product | | Acid | Rapeseed | Soybean | Stearic |
| Properties | RBDPO | Distillates | Oil | Oil | Acid |
| Pentadecane | 0-15% | 0-10% | 0-10% | 0-10% | 0-10% |
| Content | | | | | |
| Hexadecane | 25-50% | 25-50% | 0-15% | 0-20% | 0-10% |
| Content | | | | | |
| Heptadecane | 0-15% | 0-15% | 0-25% | 0-40% | 0-50% |
| Content | | | | | |
| Octadecane | 25-50% | 30-50% | 30-50% | 40-80% | 50-100% |
| Content | | | | | |

The results in Table 6 show that the process of hydrotreating RBDPO produces a high volume of n-paraffin having 16 carbon atoms and 18 carbon atoms, which is similar to the process of hydrotreating palm fatty acids. On the other hand, the processes of hydrotreating the rapeseed oil, soy bean oil and steric acid produce a high volume of n-paraffin having 17 carbon atoms and 18 carbon atoms. As such, it should be appreciated that the feedstocks comprising fats and/or fatty acids can be used as a renewable feedstock for producing a wide range of n-paraffins which then allows a wide range of PCM to be produced and obtained.

### Example 6: Preparation of Bio-Naphtha

This example describes a process for producing bio-naphtha. In particular, the hydrotreated oil was prepared according to the process described in Example 1 using the palm kernel oil and lauric acid as renewable feedstock and using the following reaction conditions:
Three reactors were used;
The reaction temperature was about 360° C.;
The reaction pressure was about 100 bar;
Fresh bio-naphtha and/or portion of the bio-naphtha recovered from the process were used as the diluent;
The ratio of the diluent to the renewable feedstock was about 85:15 by weight;
The liquid space velocity was about 10.0 hr⁻¹;
The sulphided NiCoMo/Al₂O₃ catalyst was used as the activated catalyst loaded into each reactor;
The amount of hydrogen to the renewable feedstock was about 2.2 wt %;
40% of the total hydrogen gas fed into the hydrotreating process were supplied to the first reaction zone, 30% of the total hydrogen fed into the hydrotreating proceed was supplied to the second reaction zone, and the 30% of the total hydrogen fed into the hydrotreating proceed was supplied to the third reaction zone;
The amount of hydrogen to the volume of catalyst bed in the first reactor was 600 Nm³/m³;
The amount of hydrogen to the volume of catalyst bed in the second reactor was 300 Nm³/m³;
The amount of hydrogen to the volume of catalyst bed in the third reactor was 50 Nm³/m³;
The HHPS was provided at the downstream of each reactor for separating the gaseous by-products including water vapour from the reaction effluent obtained from each reactor.

Table 7 shows the properties of the bio-naphtha obtained from the process described in Example 6.

TABLE 7

| | Feedstock | |
|---|---|---|
| Process Parameters | Palm Kernel Oil | Lauric Acid |
| Product Properties | | |
| Specific Gravity | 0.73-0.76 | 0.73-0.76 |

Distillation Range

| | | |
|---|---|---|
| Initial Boiling Point | 100-120° C. | 190-200° C. |
| Final Boiling Point | 320-330° C. | 220-230° C. |
| Paraffin Liquid (wt %) | Min 90 wt % | Min 90 wt % |
| Iso-Paraffin Content | 0-10% wt. | 0-10% wt. |
| Oxygenate Contant | Non-Detectable | Non-Detectable |
| Naphthenes Liquid | Non-Detectable | Non-Detectable |
| (vol %) | | |
| Aromatic Liquid | Non-Detectable | Non-Detectable |

Composition

| | | |
|---|---|---|
| C7 Paraffin | 0-5 wt % | 0-5 wt % |
| C8 Paraffin | 0-5 wt % | 0-5 wt % |
| C9 Paraffin | 0-5 wt % | 0-5 wt % |
| C10 Paraffin | 0-5 wt % | 0-5 wt % |
| C11 Paraffin | 0-20 wt % | 0-50 wt % |
| C12 Paraffin | 25-50 wt % | 50-95 wt % |
| C13 Paraffin | 0-10 wt % | 0-5 wt % |
| C14 Paraffin | 0-20 wt % | 0-5 wt % |
| C15 Paraffin | 0-10 wt % | Non-Detectable |
| C16 Paraffin | 0-15 wt % | Non-Detectable |
| C17 Paraffin | 0-10 wt % | Non-Detectable |
| C18 Paraffin | 10-20 wt % | Non-Detectable |

### Comparative Example 1

The comparative example 1 is in comparison to the Example 3. It was conducted by using a conventional hydrotreating process to produce a hydrotreated oil, which was prepared according to the process described in Example 2 using one reactor and the following reaction conditions;
feedstock in this experiment is RBDPO;
reaction temperature was about 320° C.;
reaction pressure was about 35 bar;
treated oil was used as the diluent;
the ratio of the diluent to the renewable feedstock was about 70:30 by weight;
the liquid space velocity was about 1.0 Hr⁻¹;
CoMo/Al₂O₃ in sulfided form was used as the activated catalyst loaded into each reactor;
the amount of hydrogen to the renewable feedstock was varied at 5.0, 5.5 and 6.0% wt; and
the HHPS was used to separate gaseous components and water vapour from the reaction effluent obtained from each reactor.

Table 8 shows the properties of the hydrotreated oil obtained from the conventional hydrotreating process

| | Hydrogen to Renewable Feedstock | | |
|---|---|---|---|
| Product Properties | 6% wt. | 5.5% wt. | 5% wt. |
| Specific Gravity | 0.77-0.79 g/ml | 0.77-0.79 g/ml | 0.77-0.79 g/ml |
| Flash Point | 60-80° C. | 60-80° C. | 60-80° C. |
| Acid Value | 0.01-0.20 | >0.20 | >0.20 |
| Iso-Paraffin Content | 0.0 to 10% wt. | 0.0 to 10% wt. | 0.0 to 10% wt. |
| Distillation Range | | | |
| Initial Boiling Point | 250 to 260° C. | 250 to 260° C. | 250 to 260° C. |
| Final Boiling | 320 to 330° C. | 320 to 330° C. | 320 to 330° C. |
| Point | | | |
| Pentadecane Content | 0-10 wt. % | 0-10 wt. % | 0-10 wt. % |
| Hexadecane Content | 20-40 wt. % | 20-40 wt. % | 20-40 wt. % |
| Heptadecane | 0-20 wt. % | 0-20 wt. % | 0-20 wt. % |
| Content | | | |
| Octadecane Content | 20-50 wt. % | 20-50 wt. % | 20-50 wt. % |

From Table 8, it is apparent that using the hydrogen recirculation rate below 6% wt, i.e., 5.5% and 5% resulted in a high acid value occurred in the obtained treated oil because the free fatty acid content in the treated oil will be increased due to an incomplete reaction and that will cause the treated oil becomes more acidic. In other words, the hydrogen recirculation rate used in the conventional hydrotreating must be at least 200% of the hydrogen consumption rate in which the hydrogen consumption rate in case of RBDPO is in range of 2.5-3.5 wt. %.

### Comparative Example 2

Yantao Bi et al had conducted a research of compositional changes during hydrodeoxygenation of biomass pyrolysis oil. The research was conducted by using the pyrolysis oil prepared from the forestry residue at a pyrolysis temperature of approximately 500° C. The hydrodeoxygenation was continuously conducted in two fixed-bed reactors. The reaction temperature in the first reactor was kept at 100° C. for stabilization, while the reaction temperature in the second reactor was maintained at 150, 210, 300, 360° C. for producing upgraded pyrolysis oils referred respectively to as UPO-1, UPO-2, UPO-3 and UPO-4.

Table 9 shows the composition of the pyrolysis oil, UPO-1, UPO-2, UPO-3 and UPO-4 obtained from hydrodeoxygenation of the pyrolysis oil.

| | Typical structure | PO | UPO-1 | UPO-2 | UPO-3 | UPO-4 |
|---|---|---|---|---|---|---|
| Carboxylic acid | 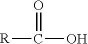 | 2.30 | 2.21 | 2.13 | 2.19 | 1.53 |
| Chain ketones and aldehydes | 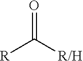 | 3.34 | 1.54 | 2.27 | 3.27 | 3.35 |
| Cyclopentatone | 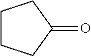 | 0.23 | 0.24 | 1.08 | 3.33 | 2.99 |
| Cyclohexanone | 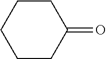 | 0.00 | 0.00 | 0.00 | 0.34 | 0.44 |
| Carbohydrate | 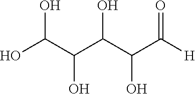 [SMILES: O=CC(O)C(O)C(O)C(O)O] | 1.65 | 0.95 | 0.29 | 0.00 | 0.00 |
| Polyhydric alcohol | 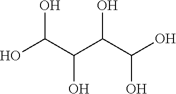 | 0.00 | 2.18 | 1.47 | 0.40 | 0.21 |
| Lower alcohol | R—OH | 1.52 | 3.81 | 4.25 | 3.03 | 1.59 |
| Ether | R—O—R | 0.58 | 0.57 | 0.87 | 0.84 | 0.68 |
| Ester | 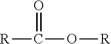 | 0.52 | 1.40 | 1.39 | 0.83 | 0.37 |
| Phenol | 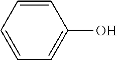 | 0.80 | 1.53 | 2.00 | 2.29 | 3.65 |
| Hydroxy-phenyl lignin | 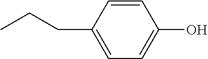 | 0.50 | 0.33 | 0.25 | 0.15 | 0.12 |
| Guaiacyl lignin | 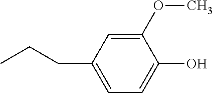 | 4.81 | 4.33 | 4.71 | 4.65 | 3.04 |
| Syringyl lignin | 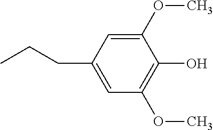 | 0.76 | 0.81 | 0.84 | 0.73 | 0.46 |
| Furan | 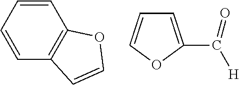 | 1.39 | 0.05 | 0.03 | 0.00 | 0.00 |
| Total | | 18.47 | 19.94 | 21.60 | 22.04 | 18.43 |

The results and also the Table above show that the UPO-1, UPO-2, UPO-3 and UPO4 obtained from processing the pyrolysis oil do not contain n-paraffin and so, these compounds cannot be used to produce the phase change materials, unlike the present invention.

### Comparative Example 3

Tables 10-14 show the solubility of hydrogen in a renewable feedstock comprising essentially triglycerides and free fatty acid, and the solubility of hydrogen in different diluted feedstocks, in which n-paraffin with different number of carbon atoms is used as a diluent to dilute the renewable feedstock comprising essentially triglycerides and free fatty acid. The tables also show that the n-paraffin having shorter number of carbon atoms provides better hydrogen solubility in the diluted feedstocks.

In some embodiments, diluents other than n-paraffin may also be used to facilitate solubility of hydrogen in the diluted feedstock. However, if other diluents than n-paraffin are used, it may cause difficulties in separating the diluents from the hydrotreated oil products, thereby incurring additional costs to the production.

Table 10 shows the solubility of hydrogen in triolein as the feedstock.

TABLE 10

| Condition | | Mass Fraction in Liquid |
|---|---|---|
| Pressure | Temperature | (hydrogen to overall |
| (bar) | (° C.) | liquid composition) |
| 20 | 340 | 0.000104 |
| 35 | 340 | 0.000171 |
| 50 | 340 | 0.000231 |
| 75 | 340 | 0.000317 |
| 100 | 340 | 0.000390 |
| 125 | 340 | 0.000452 |

Table 11 shows the solubility of hydrogen in the diluted feedstock prepared by using n-octadecane as diluent and triolein as feedstock in a ratio of 90 wt % diluent to 10 wt % feedstock.

TABLE 11

| Condition | | Mass Fraction in Liquid |
|---|---|---|
| Pressure | Temperature | (hydrogen to overall |
| (bar) | (° C.) | liquid composition) |
| 20 | 340 | 0.000314 |
| 35 | 340 | 0.000557 |
| 50 | 340 | 0.000791 |
| 75 | 340 | 0.001164 |
| 100 | 340 | 0.001518 |
| 125 | 340 | 0.001857 |

Table 12 shows the solubility of hydrogen in the diluted feedstock prepared by using n-tetradecane as diluent and triolein as feedstock in a ratio of 90 wt % diluent to 10 wt % feedstock.

TABLE 12

| Condition | | Mass Fraction in Liquid |
|---|---|---|
| Pressure | Temperature | (hydrogen to overall |
| (bar) | (° C.) | liquid composition) |
| 20 | 340 | 0.000397 |
| 35 | 340 | 0.000778 |
| 50 | 340 | 0.001146 |
| 75 | 340 | 0.001739 |
| 100 | 340 | 0.002311 |
| 125 | 340 | 0.002876 |

Table 13 shows the solubility of hydrogen in the diluted feedstock prepared by using n-dodecane as diluent and triolein as feedstock in a ratio of 90 wt % diluent to 10 wt % feedstock.

TABLE 13

| Condition | | Mass Fraction in Liquid |
|---|---|---|
| Pressure | Temperature | (hydrogen to overall |
| (Bar) | (° C.) | liquid composition) |
| 20 | 340 | 0.000404 |
| 35 | 340 | 0.000946 |
| 50 | 340 | 0.001459 |
| 75 | 340 | 0.002283 |
| 100 | 340 | 0.003068 |
| 125 | 340 | 0.003806 |

Table 14 shows the solubility of hydrogen in the diluted feedstock prepared by using the n-undecane as diluent and triolein as feedstock in a ratio of 90 wt % diluent to 10 wt % feedstock.

TABLE 14

| Condition | | Mass Fraction in Liquid |
|---|---|---|
| Pressure | Temperature | (hydrogen to overall |
| (Bar) | (° C.) | liquid composition) |
| 20 | 340 | 0.000329 |
| 35 | 340 | 0.001021 |
| 50 | 340 | 0.001657 |
| 75 | 340 | 0.003819 |
| 100 | 340 | N/A |
| 125 | 340 | N/A |

From the tables above, the results show that if n-paraffin having higher number of carbon atoms is used as the diluent, it gives lower hydrogen solubility. The results also shown that when n-dodecane having 12 carbon atoms is used as the diluent, it gives the highest hydrogen solubility. However, it is not recommended to use n-paraffin having carbon atom lower than 10 carbon atoms as diluent, because it cannot maintain its liquid phase under the reaction conditions.

It will be apparent that various other modifications and adaptations of the invention will be apparent to the person skilled in the art after reading the foregoing disclosure without departing from the spirit and scope of the invention. It is intended that all such modifications and adaptations come within the scope of the appended claims.

Further, it is to be appreciated that features from various embodiment(s), may be combined to form one or more additional embodiments.

### REFERENCES

1. Yantao Bi, Gang Wang, Quan Shi, Chunming Xu and Jinsen Guo. Compositional Changes during Hydrodeoxygenation of Biomass Pyrolysis Oil, Energy Fuels, 2014, 28, pages 2571-2580.

1. A process for producing one or more hydrocarbon products from a liquid phase renewable feedstock by way of a plurality of hydrotreating reactors including a first reactor and at least an additional reactor each of which provides a catalyst bed carrying a hydrotreating catalyst that has been activated prior to use through a sulfiding process, the renewable feedstock comprising triglycerides, free fatty acids or combinations thereof, the process comprising the steps of:
diluting the renewable feedstock with a diluent to form a diluted feedstock;
forming a diluted feedstock enriched with dissolved hydrogen by (a) contacting the diluted feedstock with hydrogen gas and subsequently adding sulfiding agent to the diluted feedstock that has been contacted with hydrogen gas, or (b) adding sulfiding agent to the diluted feedstock and subsequently contacting the diluted feedstock to which the sulfiding agent has been added with hydrogen gas, before introducing the diluted feedstock enriched with dissolved hydrogen into the first reactor;
subjecting the diluted feedstock enriched with dissolved hydrogen to the first reactor comprising a first catalyst bed to form a reaction effluent enriched with dissolved hydrogen;
further contacting the reaction effluent with hydrogen gas and sulfiding agent so that the hydrogen gas dissolves in the reaction effluent to form a reaction effluent enriched with dissolved hydrogen, before introducing the reaction effluent enriched with dissolved hydrogen into the additional reactor;
further subjecting the reaction effluent enriched with dissolved hydrogen to the additional reactor comprising an additional catalyst bed, thereby producing a further reaction effluent which can be further processed to form one or more of hydrocarbon products,
wherein gas volume fraction (GVF) of undissolved hydrogen in the additional reactor is from 0.1 to 0.25.

2. The process according to claim 1 further comprising the step of passing sulfiding agent and/or hydrogen gas through each reactor at a predefined amount.

3. The process according to claim 1 further comprising the step of separating gaseous by-products from the reaction effluent or further-reaction effluent using a hot high-pressure separator.

4. The process according to claim 1 comprising the steps of:
feeding the further-reaction effluent to a plurality of separators, which are arranged sequentially, for separating by-products, recovering n-paraffin, and obtaining a hydrotreated product;
reinjecting the recovered n-paraffin for use in the diluent to a diluent source; and
feeding the hydrotreated product to one or more distillation columns and adsorption units for purifying the hydrotreated product to obtain one or more purified hydrocarbon products.

5. The process according to claim 1, wherein the renewable feedstock is an animal oil, a plant oil, or a combination of one or more animal oils and one or more plant oils.

6. The process according to claim 1, wherein the renewable feedstock is tallow oil, train oil, fish oil, bleached palm oil (BPO), refined bleached deodorized palm oil (RBDPO), palm olein, palm stearin, palm fatty acid distillate, canola oil, corn oil, sunflower oil, soybean oil, jatropha oil, balanites oil, rapeseed oil, tall oil, hempseed oil, olive oil, linseed oil, mustard oil, peanut oil, castor oil, coconut oil, or a combination of any two or more oils.

7. The process according to claim 1, wherein the renewable feedstock is fresh oil, used oil, waste oil or any combination thereof.

8. The process according to claim 1, wherein the diluent is 70-100 wt % of n-decane(C₁₀), n-undecane(C₁), n-dodecane(C₁₂), n-tridecane(C₁₃), n-tetradecane(C₁₄) or a mixture thereof.

9. The process according to claim 1, wherein the ratio of the diluent to the renewable feedstock is about 99 wt % diluent/1 wt % feedstock to about 50 wt % diluent/50 wt % feedstock.

10. The process according to claim 1, wherein the ratio of hydrogen gas to the volume of catalyst bed in the reactor is in the range of 3 or 900 Nm³/m³, and/or the ratio of hydrogen gas to the renewable feedstock is in the range of about 10 to about 700 Nm³/m³ (about 0.001 to about 0.054 g/g).

11. The process according to claim 1, wherein the catalyst comprises at least one of two transition metals selected from the group consisting of Ni and Mo.

12. The process according to claim 11, wherein the catalyst further comprises another transition metal or a group V element, and/or the catalyst is loaded on a support.

13. The process according to claim 12, wherein the support is an acidic porous solid support selected from the group comprising alumina (Al₂O₃), silica (SiO₂) and a mixture of alumina and silica (Al₂O₃—SiO₂).

14. The process according to claim 13, wherein the support is fluoride alumina, ZSM-12, ZSM-21, ZSM-22, ZSM-23, ZSM-32, ZSM-35, ZSM-38, ZSM-48, ZSM-57, SAPO-11, SAPO-31, SAPO-41, MAPO-11, MAPO-31, zeolite Y, zeolite L or β-zeolite.

15.-32. (canceled)

33. A system for producing by way of a plurality of hydrotreating processes one or more hydrocarbon products from a renewable liquid phase diluted feedstock comprising a renewable feedstock that has been diluted with a diluent, the renewable feedstock comprising triglycerides, free fatty acids or combinations thereof, the system comprising:
a feedstock source having an output configured for providing the feedstock;
a diluent source having an output configured for providing the diluent;
a sulfiding agent source having an output configured for providing a sulfiding agent;
a hydrogen gas source having an output configured for providing hydrogen gas;
a diluted feedstock source having an input coupled to each of the output of the feedstock source, the output of the diluent source, and the sufiding agent source, and an output configured for providing diluted feedstock that has been contacted with the sulfiding agent;
an enriched diluted feedstock source having an input coupled to each of the output of the diluted feedstock source and the output of the hydrogen gas source and which is configured for contacting the diluted feedstock with hydrogen gas, and having an output configured for providing an enriched diluted feedstock comprising the diluted feedstock enriched with hydrogen dissolved therein;
a first hydrotreating reactor comprising a first activated hydrotreating catalyst bed, and having an input configured coupled to the output of the enriched diluted feedstock source for receiving the enriched diluted feedstock therein, and an output configured for providing a first effluent stream, wherein the first hydrotreating reactor is configured for hydrotreating the enriched diluted feedstock; and
an additional hydrotreating reactor comprising an additional activated hydrotreating catalyst bed and having an input coupled to each of the sulfiding agent source, the hydrogen gas source, and the output of the first hydrotreating reactor such that the first effluent stream is enriched with dissolved hydrogen therein before entry into the additional hydrotreating reactor, wherein the additional hydrotreating reactor is configured for each of passing sulfiding agent and hydrogen gas therethrough in at a predefined amount, hydrotreating the first effluent stream enriched with dissolved hydrogen therein, and providing a further effluent stream that can be further processed to form one or more hydrocarbon products,
wherein each of the first activated catalyst bed and the additional activated catalyst bed carries a hydrotreating catalyst that has been activated prior to use through a sulfidation process.

34. The system according to claim 33, further comprising:
a first hot high-pressure separator corresponding to the first reactor, the first hot high-pressure separator having an input configured for receiving the first effluent and configured for separating unwanted gaseous by-products including water vapour, carbon dioxide, carbon monoxide, propane, and hydrogen sulphide (H₂S) from the reaction effluent before further contacting the reaction effluent with hydrogen gas and sulfiding agent;
and/or
an additional hot high-pressure separator corresponding to the additional reactor, the additional hot high-pressure separator having an input configured for receiving the further reaction effluent and configured for separating unwanted gaseous by-products including water vapour, carbon dioxide, carbon monoxide, propane, and hydrogen sulphide (H₂S) from the further-reaction effluent.

35. The system according to claim 33, further comprising
a plurality of separators, which are arranged sequentially, for separating by-products, recovering n-paraffin, and obtaining a hydrotreated product; and
one or more distillation columns and adsorption units for purifying the hydrotreated product to obtain one or more purified hydrocarbon products.
